(19) United States
(12) Patent Application Publication
(10) Pub. No.: US 2015/0122586 A1
(43) Pub. Date: May 7, 2015

(54) ELEVATOR SYSTEM INCORPORATING A TRAVELING MOTOR

(71) Applicants: Franck Dominguez, Loiret (FR); Frederic Beauchaud, Coullons (FR); Nicolas Guillot, Coullons (FR)

(72) Inventors: Franck Dominguez, Loiret (FR); Frederic Beauchaud, Coullons (FR); Nicolas Guillot, Coullons (FR)

(73) Assignee: OTIS ELEVATOR COMPANY, Farmington, CT (US)

(21) Appl. No.: 14/398,323

(22) PCT Filed: May 3, 2012
(86) PCT No.: PCT/US2012/036253

§ 371 Date: Oct. 31, 2014

(51) Int. Cl. B66B 9/02; B66B 11/00

(52) U.S. Cl. CPC B66B 9/027; B66B 11/008
USPC 187/252

(57) ABSTRACT

An elevator is provided including an elevator car and a machine rail. An elevator machine is mounted to the machine rail such that the elevator machine is movable relative to the machine rail. At least one belt operatively engages both the elevator car and the elevator machine. Movement of the elevator machine relative to the machine rail causes the elevator to move.

### CROSS REFERENCE TO RELATED APPLICATIONS

This application claims the benefit of PCT International Application Ser. No. PCT/US2012/36253 filed on May 3, 2012, the contents of which are incorporated herein by reference thereto.

### BACKGROUND OF THE INVENTION

Embodiments of this invention generally relate to an elevator system, and more particularly, to an elevator system that does not include a counterweight.

Typical elevator systems generally include: an elevator car; a drive machine connected to a drive sheave; a counterweight, and a set of ropes or belts. In its simplest form, the ropes are slung across the drive sheave and connected to the car and the counterweight. The combined weight of the car and the counterweight provide enough downward force to keep the ropes and the drive sheave in frictional contact when the drive machine rotates the drive sheave. This allows for the rotation of the drive sheave to move the elevator car in a hoistway. Furthermore, connecting the elevator car and the counterweight on opposite sides of the traction sheave balances the weight of the system across the drive sheave. This balancing minimizes the torque required to rotate a drive sheave and move the elevator car.

While there are benefits to using a counterweight in a system, there are also drawbacks. For example, in order to be effective, a counterweight typically weighs at least as much as an elevator car, doubling the mass of the system and requiring sufficient power to move the increased mass every time the elevator car is moved. Counterweights are also expensive, bulky, and cumbersome to transport and install. Furthermore, counterweights typically occupy valuable building space that could be put to more valuable uses. For example, by omitting the counterweight, it is possible to accommodate a larger elevator car in an elevator shaft of a given size.

### SUMMARY OF THE INVENTION

According to an exemplary embodiment of the invention, an elevator system is provided including an elevator car and a machine rail. An elevator machine is mounted to the machine rail such that the elevator machine is movable relative to the machine rail. At least one belt is operatively engaged with both the elevator car and the elevator machine. Movement of the elevator machine relative to the machine rail causes the elevator to move.

Additionally, in this or other aspects of the invention, movement of the elevator machine translates to the elevator car through the belt.

Additionally, in this or other aspects of the invention, the elevator car includes a motor and a guide located adjacent the machine rail.

Additionally, in this or other aspects of the invention, the elevator machine includes a plurality of guides positioned adjacent opposing sides of the machine rail.

Additionally, in this or other aspects of the invention, the guide is operatively coupled to the motor and the machine rail.

Additionally, in this or other aspects of the invention, the elevator machine is configured to move relative to the machine rail in response to rotation of the guide.

Additionally, in this or other aspects of the invention, the machine rail includes a first plurality of teeth and at least one of the plurality of guides includes a second plurality of teeth. Rotation of at least one of the plurality of guides causes the first plurality of teeth engage to the second plurality of teeth to move the elevator machine relative to the machine rail.

Additionally, in this or other aspects of the invention, the elevator machine includes a deflector sheave.

According to yet another embodiment of the invention, a machine assembly mounted on a machine rail is provided including a frame and a motor. A portion of the machine assembly is movable relative to the machine rail.

Additionally, in this or other aspects of the invention, the movable portion of the machine assembly is coupled to the motor.

Additionally, in this or other aspects of the invention, a guide is mounted to the frame for engagement with the machine rail.

Additionally, in this or other aspects of the invention, the guide includes a wheel that contacts the machine rail.

Additionally, in this or other aspects of the invention, the guide includes teeth for engagement with complementary teeth of the machine rail.

Additionally, in this or other aspects of the invention, the machine assembly includes a safety mechanism that controls movement of the guide relative to the machine rail.

Additionally, in this or other aspects of the invention, the movable portion of the machine assembly is a deflector sheave.

Additionally, in this or other aspects of the invention, the deflector sheave is indirectly coupled to the motor with a ballscrew.

According to yet another embodiment of the invention, an elevator system is provided including a plurality of car guide rails and an elevator car configured to move vertically along the car guide rails. The elevator system also includes an elevator machine guide rail. An elevator machine assembly includes at least one movable component configured to move vertically along the elevator guide rail. A belt operably connects the elevator car to the at least one movable component of the machine assembly. Vertical movement of the at least one movable component of the elevator machine assembly in a first direction causes a corresponding vertical movement of the elevator car in a second, opposite direction.

Additionally, in this or other aspects of the invention, the at least one movable component of the elevator machine assembly includes a sheave.

Additionally, in this or other aspects of the invention, the elevator machine assembly also includes a drive motor that stays in a stationary position while driving the movement of the at least one movable component.

### BRIEF DESCRIPTION OF THE DRAWINGS

The subject matter, which is regarded as the invention, is particularly pointed out and distinctly claimed at the conclusion of the specification. The foregoing and other features and advantages of the invention are apparent from the following detailed description, taken in conjunction with the accompanying drawings, in which:

FIG. 1 illustrates an elevator system in a first position according to an exemplary embodiment of the invention;

FIG. 2 illustrates an alternate elevator system according to an exemplary embodiment of the invention;

FIG. 3A is another elevator system in a first position according to an exemplary embodiment of the invention;

FIG. 3B is the elevator system of FIG. 3A in a second position;

FIG. 4 is a cross-sectional detailed view of a machine assembly for use in an elevator system according to an exemplary embodiment of the invention;

FIG. 5 is a cross-sectional view of an alternate machine assembly for use in an elevator system according to an exemplary embodiment of the invention;

FIG. 6 illustrates the elevator system of FIG. 1 in a second position according to an exemplary embodiment of the invention; and

FIG. 7 illustrates an elevator system having a deflector sheave movable along a machine rail according to an embodiment of the invention.

The detailed description of the invention describes exemplary embodiments of the invention, together with some of the advantages and features thereof, by way of example with reference to the drawings.

### DETAILED DESCRIPTION OF THE INVENTION

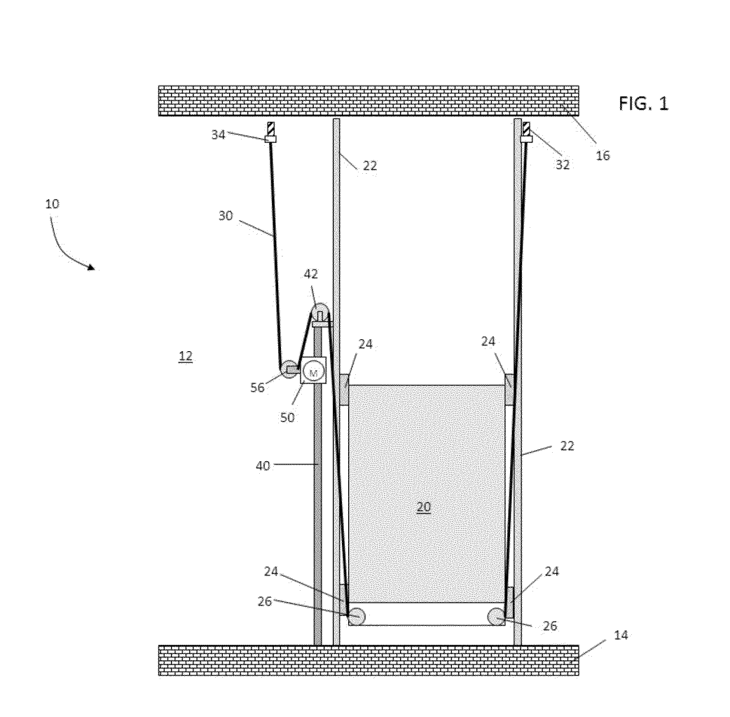

Referring now to FIG. 1, an elevator system 10 according to an exemplary embodiment of the present invention is illustrated. The elevator system 10 is located within a hoistway 12 and extends generally from a floor 14 to a ceiling 16 of the hoistway 12. The hoistway 12 may extend over the entire height of the building or over only a portion of the height of the building. While FIG. 1 depicts a two stop configuration, this is for the purposes of illustration only. The exemplary elevator system 10 is not restricted to use in low-rise applications, but can also be used in mid-rise and high-rise applications as well.

The elevator system 10 includes car guide rails 22 located on opposing sides of an elevator car 20. The car guide rails 22 guide the movement of the elevator car 20 within the hoistway 12. Guide assemblies 24 for maintaining proper alignment of the elevator car 20 as it travels along the car guide rails 22 are disposed adjacent the top and bottom of the elevator car 20. The positioning and construction of the guide assemblies 24 is not unique to the present invention. Various known guide assemblies and configurations thereof can be used without departing from the scope of the invention.

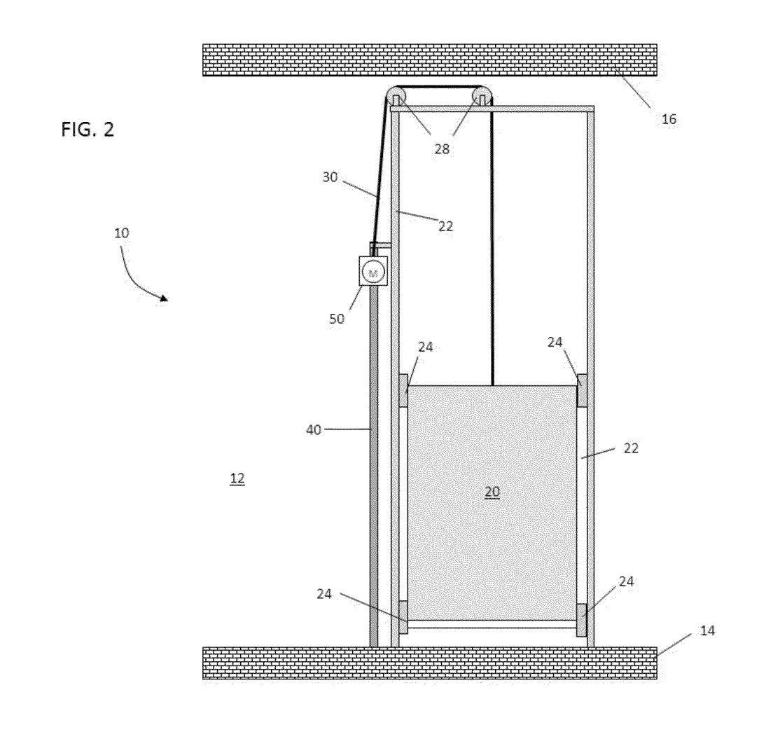

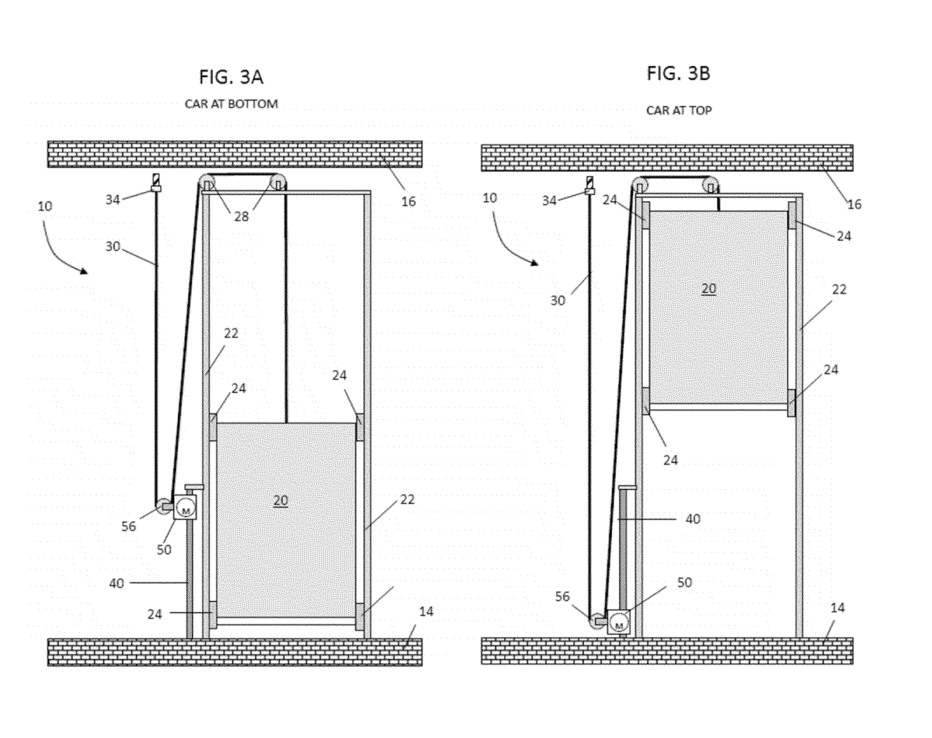

Located within the hoistway 12 is a machine rail 40. A modified car guide rail 22 may function as the machine rail 40. The machine rail 40 may have any shape and construction including that of known rails, such as an I-beam or a C-channel for example. The machine rail 40 may be secured to one of the car guide rails 22 as shown in FIG. 1, or alternately, the machine rail 40 may be secured to other components of the elevator system 10, such as, for example, a hoistway wall, or the hoistway ceiling 16. Depending on the configuration of the elevator system 10, a deflector sheave 42 may be positioned at an upper end of the machine rail 40, closest to the hoistway ceiling 16. For example, the elevator system 10 illustrated in FIG. 1 includes a deflector sheave 42, however, the alternate elevator systems illustrated in FIGS. 2 and 3 do not include this deflector sheave 42.

As further depicted in FIG. 1, a machine assembly 50 may be mounted to the machine rail 40. By supporting the machine assembly 50 on the machine rail 40, the need for a separate machine room, as required in some conventional elevator systems, is eliminated.

The elevator car 20 and the machine assembly 50 may include car sheave assemblies 26 and motor sheave assemblies 56, respectively. The sheave assemblies 26, 56 cooperate with ropes or belts (e.g. tension belts) 30 to move the elevator car 20 vertically along the car guide rails 22. In the exemplary elevator system 10 illustrated in FIG. 1, the car sheave assemblies 26 are shown mounted to the bottom of the elevator car 20. However, the car sheave assemblies 26 may be mounted to another part of the elevator car 20, such as the top of the elevator car 20 for example, or elsewhere in the elevator system 10 as known to a person skilled in the art. As illustrated, the belts 30 operatively connect the elevator car 20 to the machine assembly 50. The belt 30 is shown with a first termination at a car dead end hitch 32 located on a first side of the hoistway 12, and a second termination at an opposite dead end hitch 34 located on a second side of the hoistway 12. Both terminations are shown adjacent the ceiling 16. However, the belts 30 may terminate at other known locations, such as at the elevator car 20 and machine assembly 50, for example. Such alternate termination configurations may be more convenient when used with alternate roping arrangements, such as the exemplary elevator systems 10 illustrated in FIGS. 2 and 3.

The belts 30 of the exemplary elevator system 10 illustrated in FIG. 2 terminate directly at the car 20 and machine assembly 50, rather than at the hoistway ceiling 16. Deflector sheave 28 are mounted at the top of the hoistway 12 to control the angle of the belts 30 as they connect to the elevator car 20 and the machine assembly 50. By terminating the belts 30 at the car 20 and machine assembly 50 rather than the ceiling 16, additional components can be eliminated from the system 10, thereby reducing its overall size and complexity. The elevator system 10, shown in FIGS. 3A and 3B, combines aspects of the systems illustrated in FIGS. 1 and 2. For example, one end of the belts 30 terminates at the ceiling 16 and the opposite end of the belts 30 terminates directly at a component, such as the car 20 or machine assembly 50. The illustrated roping configurations and hoistway layouts are only exemplary, and the teachings provided herein may be applied to other system configurations.

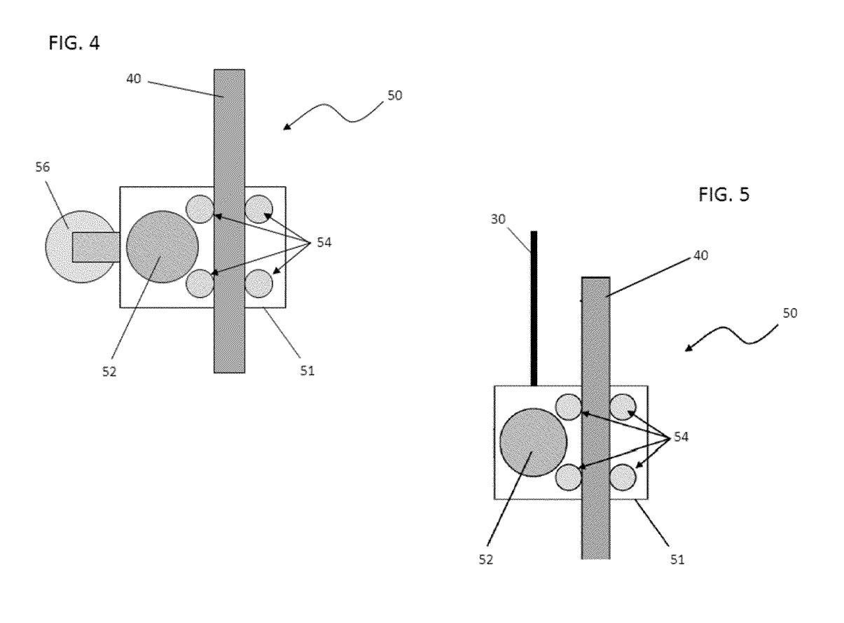

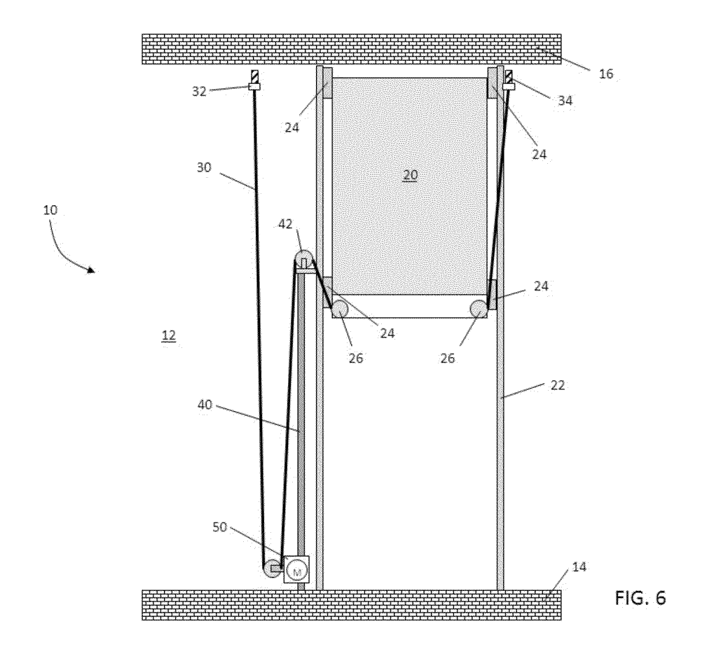

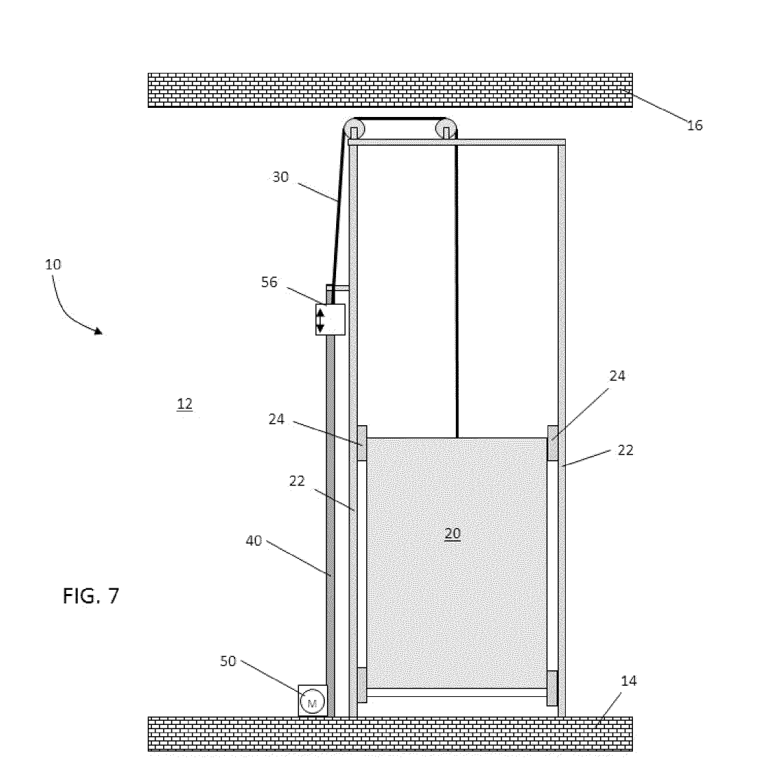

Referring now to FIG. 4 and FIG. 5, a machine assembly 50, a portion of which is movable in the hoistway 12, is illustrated in more detail. The machine assembly 50 includes a motor 52 housed within a motor frame 51. In one embodiment, a deflection sheave 56, is coupled to the motor 52, such as with a ball screw for example. The machine frame 51 may be fixed to the machine rail 40 such that rotation of the motor 52 causes the deflector sheave 56 to move vertically within the hoistway 12 and relative to the machine rail 40 (see FIG. 7). In other embodiments of the invention, the entire machine assembly 50 may be movable relative to the machine rail 40 and a deflection sheave 56 may be mounted to a portion of the motor frame 51, such as the side of the frame 51 furthest from the elevator car 20, for example. The motor frame 51 may additionally include a plurality of guides 54. The guides 54 may be positioned adjacent one side, or alternatively, two opposing sides, of the machine rail 40 to support and move the entire machine assembly 50. At least one of the guides 54 is coupled to the motor 52 such that rotation of the motor 52 is transferred to the at least one guide 54 to move the machine assembly 50 relative to the machine rail 40. In various embodiments of the invention, each guide 54 contacts the machine rail 40, so that movement of a single guide 54 imparts motion to the remainder of the plurality of guides 54.

Various mechanisms and methods may be used to move a portion of the machine assembly 50 relative to the machine rail 40. For example, as shown in FIGS. 4 and 5, the guides 54 may include wheels, at least one of which is driven by the motor 52. The wheels of the guides 54 may be held against the machine rail 40, such that the frictional contact is sufficient to provide the traction to allow the motor assembly 50 to move along the machine rail 40, and therefore to move the elevator car 20 vertically within the hoistway 12. In an alternate embodiment of the invention, the guides 54 may have a plurality of teeth and the machine rail 40 may include a corresponding plurality of notches, or complementary teeth, such that the guides 54 are physically engaged with the machine rail 40 along the length of the machine rail 40. In additional embodiments of the invention, the guides 54 may be magnetic and moved along the machine rail 40 in a manner similar to magnetic levitation. Additional mechanisms for translating components relative to one another are within the scope of this invention as recognized by persons skilled in the art. The disclosed invention is not limited to the particular exemplary embodiments disclosed herein.

Referring to FIGS. 1-3A again, elevator cars 20 of the exemplary elevator systems 10 are illustrated at positions near the bottom of their respective hoistways 12. At least a portion of each of the respective machine assemblies 50 is located at an opposite position along the machine rail 40 relative to the elevator car 20. That is, when the elevator car 20 is at a top position, a portion of the machine assembly 50 is at a bottom position, and when the elevator car 20 is at a bottom position, at least a portion of the machine assembly 50 is at a top position. Depending on the configurations of the systems, the top and bottom positions of the elevator cars 20 and the machine assemblies 50 are not necessarily at the same respective heights in the hoistways 12.

FIGS. 3B and 6 depict the exemplary elevator systems 10 of FIGS. 1 and 3A in a second position, wherein the elevator car 20 has been raised within the hoistway 12. To move the elevator car 20 from a lower position to a higher position within the hoistway 12, the motor 52 is powered, causing a portion of the machine assembly 50 to move downward along the machine rail 40. As the portion of the machine assembly 50 moves, it applies a force to the belts 30, either directly or via the deflector sheave 56 (e.g. the sheave 56 pulls a portion of the rope 30 downward). To lift the car 20 within the hoistway 12, the force applied by the motor 52 is greater than the gravitational force of the elevator car 20 and its load, thereby causing the elevator car 20 to rise as a portion of the machine assembly 50 descends.

When the movable portion of the machine assembly 50 is located at a lower position on the machine rail 40, the elevator car 20 is at a higher position within the hoistway 12. To lower the car 20, the motor 52 is run in an opposite direction, causing the movable portion of the machine assembly, such as the guides 54 or deflector sheave 56, to move in an opposite direction along the machine rail 40. In an exemplary embodiment of the invention, the engagement or interaction between the guides 54 and the machine rail 40 is strong enough to prevent slipping, or unintended motion, of the machine assembly 50 relative to the machine rail 40, such as could be caused by the gravitational force of the elevator car 20. The machine assembly 50 may also include an additional safety mechanism (not shown), similar to known safety mechanisms used on elevator cars, to prevent the movable portion of the machine assembly 50 from slipping relative to the machine rail 40.

By eliminating the need for a counterweight and a machine room, the exemplary elevator system 10 requires a smaller amount of space within a building. The elevator system 10 allows larger elevator cars, capable of carrying more people, to be used within the same hoistway space as conventional elevator systems, thereby making the system more efficient. Also, the number of belts 30 in the elevator system 10 may be reduced. Eliminating the counterweight additionally eliminates the counterweight rails, frame, filler weights and other components which ultimately reduces the cost of the system and improves the installation time.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Similarly, various features described in relation to one of the disclosed exemplary embodiments may be selectively incorporated into other embodiments of the inventions and their use is not limited to the embodiments with which they are described. Accordingly, the invention is not to be seen as limited by the foregoing description, but is only limited by the scope of the appended claims.

1. An elevator system comprising:
an elevator car;
a machine rail;
an elevator machine operatively mounted to the machine rail, wherein the elevator machine is movable relative to the machine rail; and
a belt operatively engaged with the elevator car and the elevator machine, wherein movement of the elevator machine relative to the machine rail causes the elevator car to move.

2. The elevator system according to claim 1, wherein the movement of the elevator machine is translated to the elevator car through the belt.

3. The elevator system according to claim 1, wherein the elevator machine comprises a motor and a guide located adjacent the machine rail.

4. The elevator system according to claim 3, further comprising a plurality of guides positioned adjacent opposing sides of the machine rail.

5. The elevator system according to claim 3, wherein the guide is operatively coupled to the motor and the machine rail.

6. The elevator system according to claim 5, wherein the elevator machine is configured to move relative to the machine rail responsive to a rotation of the guide.

7. The elevator system according to claim 4, wherein the machine rail comprises a first plurality of teeth, and at least one of the plurality of guides comprises a second plurality of teeth, and wherein the first plurality of teeth are configured to engage the second plurality of teeth such that a rotation of the at least one of the plurality of guides is configured to cause the elevator machine to move relative to the machine rail.

8. The elevator system according to claim 1, wherein the elevator machine comprises a deflector sheave.

9. A machine assembly to be mounted to a machine rail in an elevator system comprising:
a frame; and
a motor, wherein a portion of the machine assembly is movable relative to the machine rail.

10. The machine assembly according to claim 9, wherein the movable portion of the machine assembly is coupled to the motor.

11. The machine assembly according to claim 10, further comprising a guide mounted to the frame for engagement with the machine rail.

12. The machine assembly according to claim 11, wherein the guide includes a wheel that contacts the machine rail.

13. The machine assembly according to claim 11, wherein the guide includes teeth for engagement with complementary teeth of the machine rail.

14. The machine assembly according to claim 9, further comprising a safety mechanism that additionally controls movement of the guide relative to the machine rail.

15. The machine assembly according to claim 10, wherein the movable portion of the machine assembly is a deflector sheave.

16. The machine assembly according to claim 15, wherein the deflector sheave is indirectly coupled to the motor with a ballscrew.

17. An elevator system, comprising:
a plurality of car guide rails;
an elevator car, configured to move vertically along the car guide rails;
an elevator machine guide rail;
an elevator machine assembly, comprising at least one movable component configured to move vertically along the elevator machine guide rail; and
a belt, configured to be operably connected to the elevator car and the at least one movable component of the elevator machine assembly,
wherein, a vertical movement of the at least one movable component of the elevator machine assembly in a first direction causes a corresponding vertical movement of the elevator car in a second, substantially opposite, direction.

18. The elevator system of claim 17, wherein the at least one movable component of the elevator machine assembly comprises a sheave.

19. The elevator system of claim 17, wherein the elevator machine assembly further comprises a drive motor configured to remain in a stationary position while driving the vertical movement of the at least on movable component of the elevator machine assembly.
